(19) United States
(12) Patent Application Publication
(10) Pub. No.: US 2005/0005291 A1
(43) Pub. Date: Jan. 6, 2005

(54) Method and system for presenting broadcasting scheduled events overlapping in time

(76) Inventor: Maurice Joseph McGinley, East Frematle (AU)

Correspondence Address: Philips Electronics North America Corporation;Corporate Patent Counsel, PO Box 3001, Briarcliff Manor, NY, 10510, US

(21) Appl. No.: 10/491,876

(22) PCT Filed: Oct. 11, 2002
(86) PCT No.: PCT/IB02/04213

(30) Foreign Application Priority Data
Oct. 12, 2001 (EP) 01203909.5

(51) Int. Cl. H04N 5/445; G06F 3/00; G06F 13/00

(52) U.S. Cl. 725/44; 725/39; 725/56

(57) ABSTRACT

The present invention relates to a method of presenting broadcasting scheduled information, the method comprising the step of providing a visual representation of a plurality of scheduled events, said scheduled events having time attributes, the method further comprising a step of user-operably selecting at least one of the scheduled events. According to the method of the invention, the method comprises the further steps of determining whether any one of the scheduled events is overlapping in time with the at least one selected scheduled event (7) and visually indicating said any one of the scheduled events overlapping in time with the at least one selected scheduled event. The invention also relates to a visual representation system (101) suitable for implementing the disclosed method of presenting broadcasting scheduled information.

The present invention relates to a method of presenting broadcasting scheduled information, the method comprising the step of providing a visual representation of a plurality of scheduled events, said scheduled events having time attributes, the method further comprising a step of user-operably selecting at least one of the scheduled events.

The invention also relates to a visual representation system comprising a visual representation device, a tuner/receiver designed for receiving schedule-related information from an external broadcasting signal, a control unit comprising a means for receiving control information from an external source, means for extracting a portion of the broadcast schedule related information and for indicating visually said extracted broadcast schedule-related information on the visual representation device in a visual representation of a plurality of scheduled events, said scheduled events having time attributes, and a means for selecting one of a plurality of scheduled events carried by said broadcasting signal on the visual representation device.

An embodiment of such a method is known from U.S. Pat. No. 6,177,931. This document describes in detail an embodiment of an Electronic Program Guide (EPG), which is one of the technical areas where the method of the present invention could be used. The EPG is an interactive, on-screen feature for television systems and is an electronic alternative to traditional TV listings in newspapers or other print forms. Usually, the EPG provides program information for time periods, which can range from several hours to several days. Typically, the EPG shows the program information in the form of a time-channel grid, for instance, a two-dimensional table with time markings in columns and channel names in rows. Furthermore, program identifications for certain channels could be shown in table entries with marks to indicate program start and finish times. The program information provided by the EPG may also contain detailed information such as program title, elapsed and remaining time, short program content descriptions etc. For example, the program information could be arranged so that a user can evaluate the time of program beginning and ending as well as the remaining time for the programs being currently broadcast.

Currently known EPG systems support the display of program information in a variety of formats that are supposed to help the user analyze presented information and plan watching TV. Many basic EPG possibilities such as highlighting entries, selecting entries for further operations, navigating of program schedules for future broadcasting, switching TV to scheduled programs, scheduling future programs for recording or watching have already become common.

With the considerable increase of the number of available TV channels and variety of proposed TV programs, the EPG systems require convenient and efficient tools, not only for a navigation of the program information, but also for easy perception of represented on-screen programming information. The EPG systems provide a clear overview and highlight only the selected programs. At the same time, selecting to view a particular program implies that the user does not intend to view programs, which are overlapping in time with the selected program. Present EPG systems do not provide the user with on-screen representation of programming information that makes it evidently easy to plan the program watching list and to choose adjacent programs for continuous viewing.

It is a drawback of the known prior art that with the proliferation of broadcasts, there is a big variety of scheduled events. At the same time, without visibly indicating scheduled events overlapping in time, the user is often diverted by the information of implicitly rejected scheduled events in the representation.

It is an object of the invention to provide a method of presenting broadcasting scheduled information and a visual representation system of the kind defined in the opening paragraph which makes it easy for the user to avoid selection of the scheduled events overlapping in time. This object is realized in that the method of presenting broadcasting scheduled information comprises the further step of determining whether any one of the scheduled events is overlapping in time with the at least one selected scheduled event, and visually indicating said any one of the scheduled events overlapping in time with the at least one selected scheduled event

Thus, it is achieved that after selecting a scheduled event for further operation, like watching or recording, the method automatically prevents scheduled events beginning before the end and ending after the start of the selected scheduled event from being selected by the user. Therefore, scheduled events not overlapping with the selected scheduled event remain available for subsequent selection after and before the selected scheduled event.

Also the method of the present invention comprises a step of user-operably selecting more than one scheduled event, which does not overlap in time with the other scheduled event. This feature provide the user with a simple overview of the scheduled events overlapping in time with different selected scheduled events, and the facility to plan visibly the scheduled events for further watching, recording and other choices.

The object of the invention is also realized in that the visual representation system of the present invention comprises a means for determining whether any one of the scheduled events is overlapping in time with the at least one selected scheduled event, a means for visually indicating said any one of the scheduled events overlapping in time with the at least one selected scheduled event. In this way, the visual representation system of the present invention is designed to implement the disclosed method of presenting broadcasting scheduled information as well as all the included advantages of the proposed method.

In addition to the visual representation device, the visual representation system further comprises means for operating with scheduled events, like means for recording scheduled events etc. In the case in which more than one tuner/receiver is available, the visual representation system of the invention would visibly represent and distinguish between viewing and other possible choices of operating with scheduled events, like recording. Therefore, the scheduled event could be selected simultaneously for the several choices of operating with scheduled events.

These and other aspects of the invention will be further elucidated and described with references to the accompanying drawings, wherein:

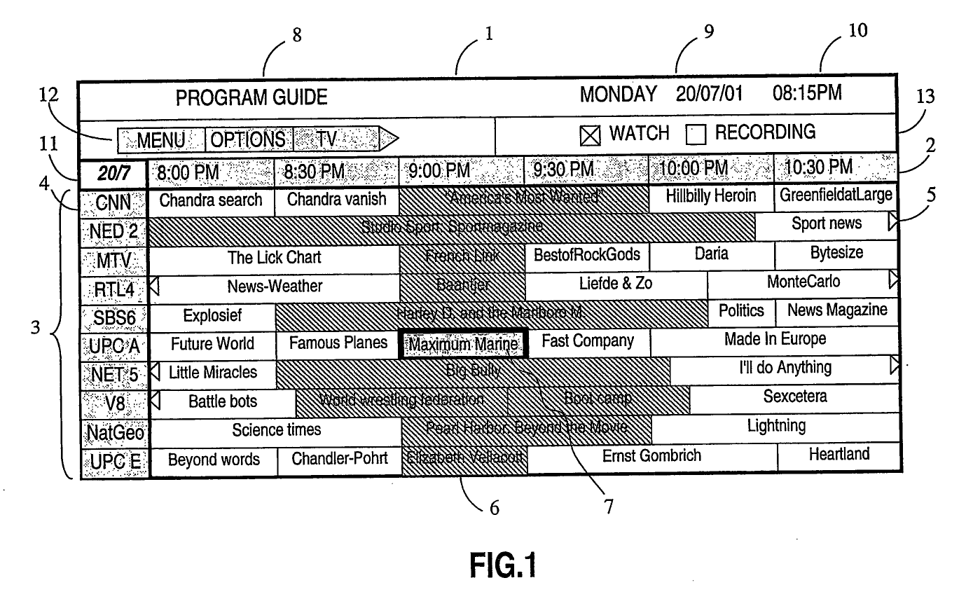

FIG. 1 shows an embodiment of the method of presenting broadcasting scheduled information, as applied to the field of EPG, in which a two-dimensional representation of program-related information is shown;

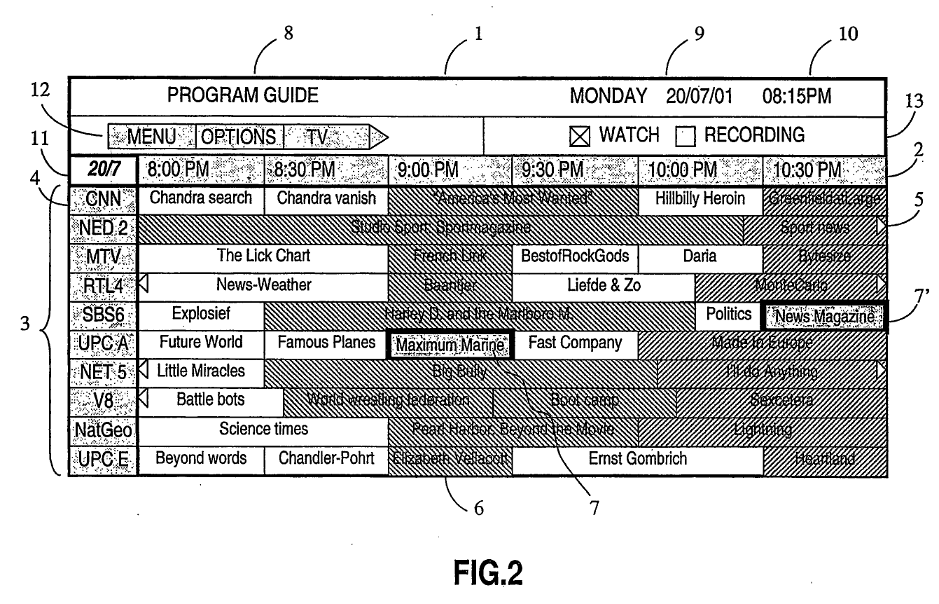

FIG. 2 shows an embodiment of the method of presenting broadcasting scheduled information, as applied to the field of EPG, in which the two-dimensional representation of program-related information is shown with a three-hour time period and the number of channels with a plurality of programs, visually indicating two selected programs;

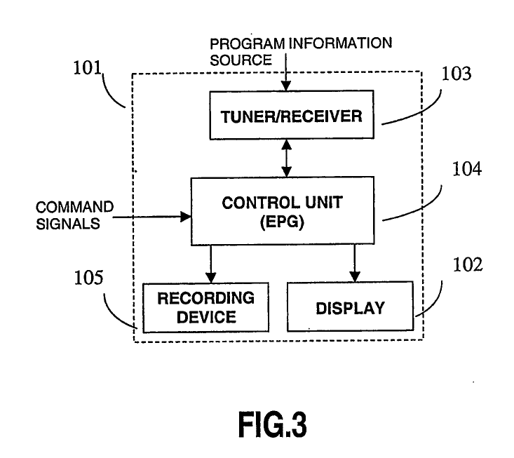

FIG. 3 shows a functional block diagram of the visual representation system in the form of a television system suitable for implementing the present invention.

FIG. 1 shows an embodiment of the method of presenting broadcasting scheduled information, as applied to the field of EPG, in which a two dimensional representation of television program-related information is shown. A plurality of television programs is illustrated as an example of the plurality of scheduled events. In this case, time attributes of scheduled events are visually indicated by means of introducing a time axis of the two-dimensional representation. The programs are positioned with respect to a time indicator with a three-hour period. A channel axis and the time axis create said two-dimensional representation of the program-related information. A number of channels shown in a vertical list incorporate the plurality of programs. It should be clearly understood that the time attributes of scheduled events could be indicated in a different way and scheduled events could be positioned in a manner different from that described in this document.

In FIG. 1, a television system display 1 is shown as the visual representation device. The terms of graphical indicating or displaying is used further in the description as the particular cases of the visual indication of the visual representation system. The time axis of the two-dimensional representation is displayed as the time indicator line 2 divided into half-hour sections including indication of the starting time of the particular section. The channel axis is displayed as a vertical section 3 divided into bars 4, for instance, indicating channel titles. The plurality of programs for the corresponding channel is displayed inside a program area. A particular program is depicted as a rectangle placed on a line of the corresponding channel and limited by vertical lines indicating the time when a program begins and ends. Thus, the user is able to evaluate the program start time and the program and time, taking into consideration the time indicated by the time indicator line 2. A particular program could be extended in time for more than the half-hour section. If the program spans more in time length than a window of the time indicator line, there is an end arrow 5 adjacent to the program end vertical line.

The visual representation system of the invention determines whether any one of the scheduled events, for instance the television programs, is overlapping in time with the at least one selected scheduled event, i.e. the television program. In particular, the method of the present invention could be implemented in the manner described below. For example, it can be evaluated which overlapping programs begin before the start of the selected program and end during or after the period of broadcasting the selected program. Programs that begin during the period of broadcasting the selected program are also considered to be overlapping programs. Therefore, programs that meet the requirements stated above would be rated as overlapping in time and are graphically indicated in the representation relative to the selected program.

User-operable selection of a program may be accomplished in a number of ways—using a remote control unit, EPG tools, any pointing devices including a mouse, a joystick etc. For example, the program selected by a user can be highlighted by adding a border around the program rectangle or by changing the color of the border or rectangle area In this way, the selected program is displayed in a manner different from the other programs. Furthermore, given programs overlapping in time are represented as shaded or hatched. As a result, the selected program and the programs overlapping in time are displayed differently from each other and from the rest of the programs as well. Visual indication of selected and scheduled events overlapping in time could be done in a number of ways, but this aspect cannot change the scope of the present invention.

In addition to the above, the television system display 1 displays the program guide name 8, a current date 9, a current time in text format 10, a viewing guide date 11, a menu bar 12, and options 13 for watching and recording the selected program.

In FIG. 2 those elements that correspond to the elements shown in FIG. 1, are indicated by the same reference numerals. Terms used to describe FIG. 2 could be interpreted as the terms used in the description of FIG. 1.

With reference now to FIG. 2, there is depicted the embodiment of the method of presenting broadcasting scheduled information, as applied to the field of EPG. The Figure shows the two-dimensional representation of program-related information with the three-hour time period and the number of channels with a plurality of programs. Two selected programs 7 and 7′, the programs overlapping in time with the selected programs and the remaining programs are visually indicated on the representation differently from each other. The scheduled events overlapping in time with the two selected scheduled events are shown as hatched. Hence, a further advantage of the invention is an increased ease of using it when the user would like to compose an uninterrupted list of the scheduled events for further operation, particularly the list of the programs to be watched or recorded in future. The user will have a clear overview of all adjacent programs, which are still available for further selection. The scheduled events overlapping in time with different selected scheduled events may be displayed differently from each other, both from the selected scheduled events and from the remaining scheduled events. The user could thus visibly recognize the scheduled events, like the programs, overlapping with different selected scheduled events, for example by means of different hatching.

In this embodiment, there are at least two methods of implementing program selection that could be realized. The first method may be understood as comprising a step of moving the on-screen cursor to highlight the program being currently active, and further comprising a step of graphically indicating that program as being selected after executing the command from the control device. For this purpose, a defined key of a remote control unit, interactive means and EPG tools, information received from the user by means of an Internet connection etc. could be used for generating such a command. In the first method, the programs overlapping in time will be determined and displayed after receiving the selecting command. Unlike the first method, the alternative second method may include the steps of determining and displaying the programs overlapping in time for every position of the moving on-screen cursor, and of fixing this program as being selected after receiving the command from the control devices.

The invention provides means for avoiding selection of scheduled events, which are overlapping in time, for simultaneous operation. This situation may occur when the invention comprises apparatuses operating with the scheduled event for the non-identical choices, like watching and recording choices, and the particular apparatus can operate with only one scheduled event at a time. Therefore, only one scheduled event can be selected and planned for further operation during the specific period of time. According to the embodiment of the invention, the method includes a step of avoiding a further selection for watching the program, which overlaps in time with the program being already selected for watching. In other words, only one program can be selected at the same time for watching or another choice, when the visual representation system includes more than one means for operating with scheduled events for the non-identical choices.

If the visual representation system, like the television system, of the invention includes more than one tuner/receiver, the method of the invention may further comprise, for example, a step of selecting the program for simultaneous watching and recording. In this case, the method is extended to a possible selection for recording the program overlapping in time with the program being already selected for watching, and vice versa. It would be possible to select watching the program overlapping in time with the program being already selected for recording.

It could be optional for the user to use the method of the present invention that comprises the step of determining and visually indicating a “degree” of the overlap. The “degree” of overlap of the scheduled events could be estimated on the basis of a reference overlapping time indicated in user preferences of the television system. When scheduled events overlap with the selected scheduled events for a time which is less than or equal to the reference overlapping time of the user preferences, these scheduled events overlapping in time would be displayed as not overlapping and considered as possible events for further selection. The reference overlapping could be optionally set by the manufacturer of the visual representation system, or by the user, and this time may be equal to, for instance, five, ten, fifteen etc minutes. The reference overlapping time could also be considered as dependent on the program length and be set in percents of the program length.

FIG. 3 shows a functional block diagram of the visual representation system in the form of a television system, which is suitable for implementing the present invention.

The television system 101 comprises a display device 102, as a visual representation device, a tuner/receiver 103 designed for receiving television programs from an external television signal, such as scheduled events being received from an external broadcasting signal, a control unit 104 coordinating the general operation of the television system, and a recording device 105.

The control unit 104 includes means for receiving control information from an external source, means for extracting a portion of the program-related information and for displaying extracted program information on the display device in the representation described above, and means for selecting one of a plurality of scheduled events carried by said broadcasting signal on the visual representation device. The control unit 104 preferably incorporates a microprocessor and a memory or microcontroller. Control unit 104 also produces a signal for the display device 101 and the recording device 105, suitable for implementing the present invention. The control unit reacts in response to the program information made available by the tuner/receiver 103 and the user command received from the remote control unit, from the EPG system or via an Internet connection etc.

The visual representation system suitable for implementing the method of the present invention further comprises means for determining whether any one of the scheduled events is overlapping in time with the at least one selected scheduled event, like the programs, and means for visually indicating said any one of the scheduled events overlapping in time with the at least one selected scheduled event.

The visual representation system also includes means for operating with scheduled events, for example, the means for recording scheduled events. As regards the embodiment, the television system may also have a facility for selecting programs to be watched, recorded or watched and recorded simultaneously.

It could be useful for the user to have a means for activating a mode of scheduled events overlapping in time. For example, an additional key of the remote control unit could implement this mode on the television system. Any functions provided by buttons on the remote control unit may be provided by pull-down menus, by displayed virtual buttons or by any other suitable devices and methods. All of these functions could be implemented by the microprocessor referred to above. Further details of the internal design of the described embodiment of the visual representation system will be apparent to those skilled in the art and are not discussed herein.

Although the invention has been described with reference to the particular EPG embodiments, there are many other fields of application of the present invention. The method of the invention may also be applied for presenting radio scheduled information, for broadcasting information in the networks, for presenting information about transports schedules etc. With radio scheduled information, the scheduled events could be interpreted as broadcast radio programs. All of the radio scheduled information could be presented and processed by means of a visual representation system with a certain display device and remote control unit. The radio program information could be shown in the manner as disclosed in this document.

Variations and modifications of the used embodiment are possible within the scope of the inventive concept. For instance, different representation types of broadcasting scheduled information and modified steps for selecting scheduled events could be realized. The various software may implement the functions of the visual representation system and may be combined in several ways with hardware or located in different devices, e.g. a set-top box, a PC equipped with a tuner card, a video recorder or any other devices suitable for broadcasting signal reception or processing.

1. A method of presenting broadcasting scheduled information, the method comprising the steps of providing a visual representation of a plurality of scheduled events, said scheduled events having time attributes, the method further comprising a step of user-operably selecting at least one of the scheduled events, characterized in that the method comprises, the further steps of:
determining whether any one of the scheduled events is overlapping in time with the at least one selected scheduled event; and
visually indicating said any one of the scheduled events overlapping in time with the at least one selected scheduled event.

2. The method of claim 1, further comprising the step of visually indicating the selected scheduled event, the overlapping in time of scheduled events and the remaining scheduled events on the representation differently from each other.

3. The method of claim 1, in which the step of user-operable selection comprises selecting more than one scheduled event, which does not overlap in time, the method further comprising a step of visually indicating all of the selected scheduled events and visually indicating all of the scheduled events overlapping in time with at least one of the selected scheduled events.

4. The method of claim 3, in which scheduled events overlapping in time with different selected scheduled events are visually indicated differently from each other, from the selected scheduled events and from the remaining scheduled events.

5. The method of claim 1, further comprising the step of moving a visually indicated cursor, wherein the visual representation of the overlapping scheduled events comprises visual indication of the overlapping scheduled events in a manner different from the other scheduled events at the time of moving said visually indicated cursor.

6. The method of claim 1, wherein the step of visually indicating the time-overlapping scheduled events comprises providing means for avoiding selection of the time-overlapping scheduled events.

7. The method of claim 1, further comprising the step of providing the visual representation of the plurality of scheduled events with a time axis, wherein the time axis visually indicates the time attributes of the scheduled events, the representation visually indicating at what times at least one of the scheduled events begins and ends.

8. The method of claim 7, comprising the step of presenting program information, wherein programs are the scheduled events with time attributes.

9. The method of claim 8, further comprising the step of providing a two-dimensional representation of program information with a channel axis, including at least two channels in the representation, wherein each channel comprises a plurality of programs.

10. A visual representation system comprising:
a visual representation device;
a tuner/receiver designed for receiving schedule-related information from an external broadcasting signal;
a control unit comprising:
means for receiving control information from an external source;
means for extracting a portion of the broadcast schedule-related information and for indicating visually said extracted broadcast schedule-related information on the visual representation device in a visual representation of a plurality of scheduled events, said scheduled events having time attributes;
means for selecting one of a plurality of scheduled events carried by said broadcasting signal on the visual representation device;
characterized in that the visual representation system further comprises:
means for determining whether any one of the scheduled events is overlapping in time with the at least one selected scheduled event;
means for visually indicating said any one of the scheduled events overlapping in time with the at least one selected scheduled event.

11. The visual representation system of claim 10, wherein, in addition to the visual representation device, the system further comprises means for operating with scheduled events.

12. The visual representation system of claim 11, in which the means for operating with scheduled events comprise means for recording scheduled events and wherein scheduled events can be selected for watching or recording.

13. The visual representation system of claim 10, further comprising more than one tuner/receiver designed for receiving schedule-related information from the external broadcasting signal.

14. The visual representation system of claims 12, wherein at least one scheduled events can be selected for watching and recording simultaneously.

15. A television system, such as the visual representation system defined in claim 10, comprising:
a display device;
a tuner/receiver designed for receiving program-related information from an external television signal;
a control unit comprising:
means for receiving control information from an external source;
means for extracting a portion of the program-related information and for displaying said extracted program information on the display device in a two-dimensional representation of the program-related information with a time axis and a channel axis, including at least two channels in the representation, wherein each channel comprises a plurality of programs, the representation displaying at what times at least one of the programs begins and ends;
means for selecting one of a plurality of programs carried by said external television signal on the display device;
characterized in that the television system further comprises:
means for determining whether any one of the programs is overlapping in time with the at least one selected program;
means for visually indicating said any one of the programs overlapping in time with the at least one selected program.

16. A computer program product enabling a programmable device when executing said computer program product to function as the visual representation system as defined in claim 10.
